(19) United States
(12) Patent Application Publication
(10) Pub. No.: US 2012/0008674 A1
(43) Pub. Date: Jan. 12, 2012

(54) MULTITHREAD PROCESSOR AND DIGITAL TELEVISION SYSTEM

(75) Inventors: Takao YAMAMOTO, Osaka (JP); Shinji OZAKI, Osaka (JP); Masahide KAKEDA, Ibaraki (JP); Masaitsu NAKAJIMA, Osaka (JP)

(73) Assignee: PANASONIC CORPORATION, Osaka (JP)

(21) Appl. No.: 13/209,804

(22) Filed: Aug. 15, 2011

Related U.S. Application Data
(63) Continuation of application No. PCT/JP2010/000939, filed on Feb. 16, 2010.

(30) Foreign Application Priority Data
Feb. 17, 2009 (JP) 2009-034471
Jul. 29, 2009 (JP) PCT/JP2009/003566

(51) Int. Cl. H04N 11/02; G06F 12/10

(52) U.S. Cl. 375/240.01; 711/207; 711/E12.061; 375/E07.026

(57) ABSTRACT

A multithread processor including: an execution unit including a physical processor; and a translation lookaside buffer (TLB) which converts, to a physical address, a logical address output from the execution unit, and logical processors are implemented on the physical processor, a first logical processor that is a part of the logical processors constitutes a first subsystem having a first virtual space, a second logical processor that is a part of the logical processors and different from the first logical processor constitutes a second subsystem having a second virtual space, each of the first and the second subsystems has processes to be assigned to the logical processors, and the logical address includes: a first TLB access virtual identifier for identifying one of the first and the second subsystems; and a process identifier for identifying a corresponding one of the processes in each of the first and the second subsystems.

### CROSS REFERENCE TO RELATED APPLICATION

This is a continuation application of PCT application No. PCT/JP2010/000939 filed on Feb. 16, 2010, designating the United States of America.

### BACKGROUND OF THE INVENTION

(1) Field of the Invention

The present invention relates to multithread processors and digital television systems, and relates particularly to a multithread processor which simultaneously executes a plurality of threads.

(2) Description of the Related Art

Along with rapid development of digital technology and audio-visual compression and decompression techniques in recent years, higher performance is expected of a processor incorporated in a digital television, a digital video recorder (DVD recorder and so on), a cellular phone, and a video sound device (camcoder and so on).

For example, a multithread processor is known as a processor which realizes high performance (for example, see Patent Reference 1: Japanese Unexamined Patent Application Publication 2006-302261).

This multithread processor can improve processing efficiency by simultaneously executing a plurality of threads. In addition, the multithread processor can improve, in executing the threads, area efficiency of the processor as compared to the case of providing a plurality of processors independently.

On the other hand, such a processor performs: control-related host processing which does not require real-timeness; and media processing such as compression and decompression which require real-timeness.

For example, an audio-visual processing integrated circuit described in Patent Reference 2 (International Publication 2005/096168) includes: a microcontroller block for performing host processing and a media processing block for performing media processing.

### SUMMARY OF THE INVENTION

However, such a multithread processor as disclosed in Patent Reference 1 has a problem of deterioration in assurance and robustness of performance due to competition among a plurality of threads sharing a resource at the same time. Specifically, when the resource, which is used for media processing such as the data stored in a cache memory, is driven out by host processing, it becomes necessary to re-cache the data by the media processing. This makes it difficult to assure performance of the media processing.

In addition, in the multithread processor in Patent Reference 1, it is necessary to control an influence of the other processing even in designing, and therefore the designing of the multithread processor is more complicated than in the case of including a microcontroller block and a media processing block such as an audio-visual processing integrated circuit as disclosed in Patent Reference 2. Furthermore, the robustness of the system decreases due to increase in possibility of occurrence of an unexpected failure.

On the other hand, the audio-visual processing integrated circuit in Patent Reference 2, allows suppression of deterioration in assurance and robustness of performance because a microcontroller block for executing host processing and a media processing block for performing media processing are separately provided. However, the audio-visual processing integrated circuit in Patent Reference 2 includes, separately, the microcontroller block for performing host processing and the media processing block for performing media processing, and this does not allow efficient sharing of resources. Accordingly, the audio-visual processing integrated circuit in Patent Reference 2 has a problem of poor area efficiency of the processor.

Thus, an object of the present invention is to provide a multithread processor which allows increasing assurance and robustness of performance as well as increasing area efficiency.

To achieve the above object, a multithread processor according to an aspect of the present invention is a multithread processor which simultaneously executes a plurality of threads, and the multithread processor includes: a plurality of resources used for executing the threads; a holding unit which holds tag information indicating whether each of the threads is a thread belonging to host processing or a thread belonging to media processing; a division unit which divides the resources into a first resource associated with the thread belonging to the host processing and a second resource associated with the thread belonging to the media processing; an allocation unit which allocates, with reference to the tag information, the first resource to the thread belonging to the host processing, and the second resource to the thread belonging to the media processing; and an execution unit which executes the thread belonging to the host processing, using the first resource allocated by the allocation unit, and executes the thread belonging the media processing, using the second resource allocated by the allocation unit.

With this configuration, the multithread processor according to an aspect of the present invention can improve area efficiency by sharing the resources between the host processing and media processing. Furthermore, the multithread processor according to an aspect of the present invention can allocate an independent resource to each of the host processing and media processing. With this, since no competition for the resource occurs between the host processing and the media processing, the multithread processor according to an aspect of the present invention can increase assurance and robustness of performance.

In addition, the execution unit may execute: a first operating system which controls the thread belonging to the host processing; a second operating system which controls the thread belonging to the media processing; and a third operating system which controls the first operating system and the second operating system, and the division by the division unit may be performed by the third operating system.

In addition, each of the resources may include a cache memory including a plurality of ways, the division unit may divide the ways into a first way associated with the thread belonging to the host processing and a second way associated with the thread belonging to the media processing, and the cache memory may cache, to the first way, data of the thread belonging to the host processing, and may cache, to the second way, data of the thread belonging to the media processing.

With this configuration, the multithread processor according to an aspect of the present invention shares the cache memory between the host processing and the media processing, and can also assign an independent area in the cache memory to each of the host processing and media processing.

In addition, the multithread processor may execute the threads, using a memory, each of the resources may include a translation lookaside buffer (TLB) having a plurality of entries each indicating a correspondence relationship between a logical address and a physical address of the memory, the division unit may divide the entries into a first entry associated with the thread belonging to the host processing and a second entry associated with the thread belonging to the media processing, and the TLB, with reference to the tag information, may use the first entry for the thread belonging to the host processing, and may use the second entry for the thread belonging to the media processing.

With this configuration, the multithread processor according to an aspect of the present invention shares the TLB between the host processing and the media processing, and can also allocate an independent TLB entry to each of the host processing and media processing.

In addition, each of the entries may further include the tag information, and one physical address may be associated with a pair of the logical address and the tag information.

According to this configuration, the multithread processor according to an aspect of the present invention can also allocate an independent logical address space to each of the host processing and media processing.

In addition, the multithread processor may execute the threads, using a memory, each of the resources may include a physical address space of the memory, and the division unit may divide the physical address space of the memory into a first physical address range associated with the thread belonging the host processing and a second physical address range associated with the thread belonging to the media processing.

With this configuration, the multithread processor according to an aspect of the present invention can also allocate an independent logical address space to each of the host processing and media processing.

In addition, the multithread processor may further include a physical address management unit which generates an interrupt both when the thread belonging the media processing accesses the first physical address range and when the thread belonging to the host processing accesses the second physical address range.

With this configuration, the multithread processor according to an aspect of the present invention can generate an interrupt when each of threads for the host processing and the media processing attempts to access the memory area being used by a thread for other processing. With this, the multithread processor according to an aspect of the present invention can increase system robustness.

In addition, the multithread processor may execute the threads, using a memory, the multithread processor may further include a memory interface unit which accesses the memory in response to a request from the thread belonging to the host processing and the thread belonging to the media processing, each of the resources may be a bus bandwidth between the memory and the memory interface unit, the division unit may divide the bus bandwidth into a first bus bandwidth associated with the thread belonging to the host processing and a second bus bandwidth associated with the thread belonging to the media processing, and the memory interface unit, with reference to the tag information, may access the memory, using the first bus bandwidth, when the thread belonging to the host processing requests an access to the memory, and may access the memory, using the second bus bandwidth, when the thread belonging to the media processing requests an access to the memory.

With this configuration, the multithread processor according to an aspect of the present invention can assign an independent bus bandwidth to each of the host processing and media processing. With this, the multithread processor according to an aspect of the present invention can achieve performance assurance and real-time execution of each of the host processing and media processing.

In addition, each of the resources may include a plurality of floating point number processing units (FPU), and the division unit may divide the FPUs into a first FPU associated with the thread belonging to the host processing and the a second FPU associated with the thread belonging to the media processing.

With this configuration, the multithread processor according to an aspect of the present invention shares the FPUs between the host processing and the media processing, and can also assign an independent FPU to each of the host processing and media processing.

In addition, the division unit may set one of the threads that corresponds to an interrupt factor, and the multithread processor may further include an interrupt control unit which transmits, when the interrupt factor occurs, an interrupt to the one of the threads that corresponds to the interrupt factor.

With this configuration, the multithread processor according to an aspect of the present invention can also perform an independent interrupt control to each of the host processing and the media processing.

In addition, the host processing may be performing system control, and the media processing may be performing one of compression and decompression on video.

Note that the present invention can be realized not only as such a multithread processor as described above but also as a control method for a multithread processor which includes, as steps, characteristic units included in the multithread processor, and can also be realized as a program for causing a computer to execute such characteristic steps. In addition, it goes without saying that such a program can be distributed via a recording medium such as a compact disc read-only memory (CD-ROM) and a transmission medium such as the Internet.

Furthermore, the present invention can be realized as a semiconductor integrated circuit (LSI) which realizes part or all of functions of such a multithread processor, and can also be realized as a digital television system, a DVD recorder, a digital camera, and a cellular phone device including such a multithread processor.

As described above, according to the present invention, it is possible to provide a multithread processor which allows increasing assurance and robustness of performance as well as increasing area efficiency.

### FURTHER INFORMATION ABOUT TECHNICAL BACKGROUND TO THIS APPLICATION

The disclosures of Japanese Patent Application No. 2009-034471 filed on Feb. 17, 2009 and International Application No. PCT/JP2009/003566 filed on Jul. 29, 2009, including specification, drawings and claims, are incorporated herein by reference in its entirety.

The disclosure of PCT application No. PCT/JP2010/000939 filed on Feb. 16, 2010, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a configuration of a processor system according to an embodiment of the present invention;

FIG. 2 is a block diagram showing a configuration of a processor block according to the embodiment of the present invention;

FIG. 3 is a diagram showing a configuration of context according to the embodiment of the present invention;

FIG. 4 is a diagram showing management of a logical address space according to the embodiment of the present invention;

FIG. 5 is a diagram showing a configuration of a PSR according to the embodiment of the present invention;

FIG. 6 is a diagram showing a configuration of an address management table according to the embodiment of the present invention;

FIG. 7 is a diagram showing a correspondence relationship between a logical address and a physical address according to the embodiment of the present invention;

FIG. 8 is a diagram showing a configuration of an entry specification register according to the embodiment of the present invention;

FIG. 9 is a diagram showing processing for allocating entries by a TLB according to the embodiment of the present invention;

FIG. 10 is a flowchart showing a flow of processing by the TLB according to the embodiment of the present invention;

FIG. 11 is a diagram showing a configuration of a physical protection register according to the embodiment of the present invention;

FIG. 12 is a diagram showing a physical address space protected by a PVID according to the embodiment of the present invention;

FIG. 13 is a diagram showing a configuration of a protection violation register according to the embodiment of the present invention;

FIG. 14 is a diagram showing a configuration of an error address register according to the embodiment of the present invention;

FIG. 15 is a diagram showing a configuration of an FPU allocation register according to the embodiment of the present invention;

FIG. 16 is a diagram showing FPU allocation processing performed by an FPU allocation unit according to the embodiment of the present invention;

FIG. 17A is a diagram showing a configuration of a way specification register according to the embodiment of the present invention;

FIG. 17B is a diagram showing a configuration of a way specification register according to the embodiment of the present invention;

FIG. 18 is a diagram schematically showing way allocation processing performed by a cache memory according to the embodiment of the present invention;

FIG. 19 is a flowchart showing a flow of processing by the cache memory according to the embodiment of the present invention;

FIG. 20 is a diagram showing a configuration of an interrupt control register according to the embodiment of the present invention;

FIG. 21 is a diagram showing memory access management in a processor system according to the embodiment of the present invention;

FIG. 22 is a diagram showing a bus bandwidth allocation performed by a memory IF block according to the embodiment of the present invention; and

FIG. 23 is a flowchart showing a flow of resource division processing in a processor system according to the embodiment of the present invention.

### DESCRIPTION OF THE PREFERRED EMBODIMENT

Hereinafter, an embodiment of a processor system according to the present invention will be described with reference to the drawings.

A processor system according to an embodiment of the present invention includes a single processor block which performs, sharing a resource, host processing and media processing. Furthermore, the processor system according to the embodiment of the present invention assigns different tag information to each of threads for host processing and threads for media processing, and divides resources of the processor system in association with the tag information. This allows the processor system according the embodiment of the present invention to increase assurance and robustness of performance as well as increasing area efficiency.

First, a configuration of the processor system according to the embodiment of the present invention is described.

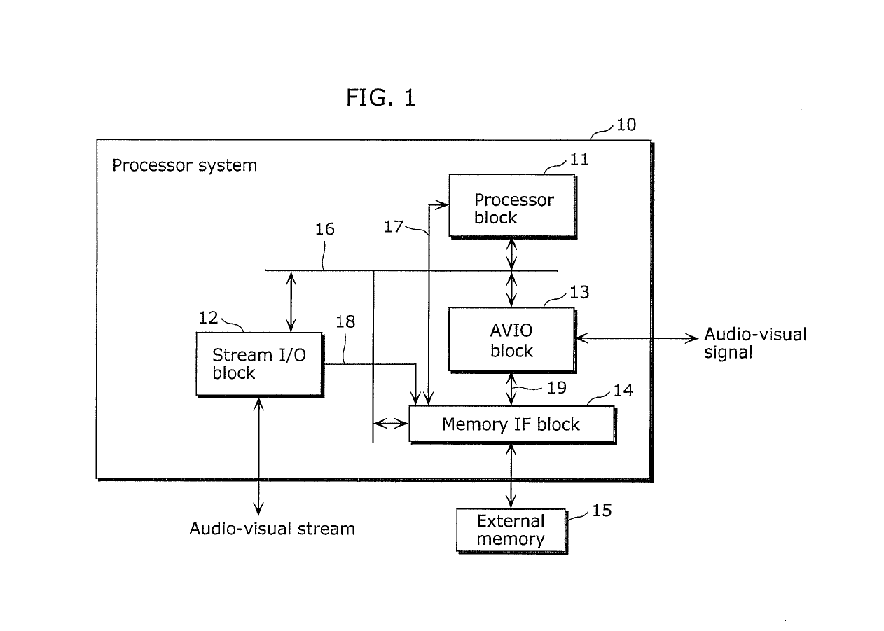

FIG. 1 is a block diagram showing a configuration of a processor system 10 according to the embodiment of the present invention.

The processor system 10 is a system LSI which performs a variety of signal processing related to an audio-visual stream, and performs a plurality of threads using an external memory 15. For example, the processor system 10 is incorporated in a digital television system, a DVD recorder, a digital camera, a cellular phone device, and so on. The processor system 10 includes: a processor block 11, a stream I/O block 12, an audio-visual input output (AVIO) block 13, and a memory IF block 14.

The processor block 11 is a processor which controls an entire processor system 10, and controls the stream I/O block 12, the AVIO block 13, and the memory IF block 14 via a control bus 16, or accesses the external memory 15 via a data bus 17 and the memory IF block 14. In addition, the processor block is a circuit block which: reads audio-visual data such as a compressed audio-visual stream from the external memory 15 via the data bus 17 and the memory IF block 14; and stores again, after performing media processing such as compression or decompression, processed image data or audio data in the external memory 15.

In other words, the processor block 11 performs host processing that is non-real time general-purpose (control-related) processing that is independent of an audio-visual output cycle (frame rate and so on) and media processing that is real-time general-purpose (media-related) processing that is dependent on an audio-visual output cycle.

For example, in the case of incorporating the processor system 10 in the digital television system, the digital television system is controlled by host processing, and digital video is decompressed by media processing.

The stream I/O block 12 is a circuit block which, under control by the processor block 11, reads stream data such as a compressed audio-visual stream from a peripheral device such as a storage media and a network, and stores the read stream data into the external memory 15 via the data bus 18 and the memory IF block 14 or performs stream transfer in an inverse direction. Thus, the stream I/O block 12 performs non-real time processing independent of the audio-visual output cycle.

The AVIO block 13 is a circuit block which, under the control of the processor block 11, reads image data, audio data, and so on from the external memory 15 via the data bus 19 and the memory IF block 14, and, after performing a variety of graphic processing and so on, outputs the processed data as an image signal and an audio signal to a display apparatus, a speaker, or the like that is provided outside, or performs data transfer in an inverse direction. Thus, the AVIO block 13 performs real-time processing dependent on the audio-visual output cycle.

The memory IF block 14 is a circuit block which performs control, under the control of the processor block 11, such that a data request is issued in parallel between each of the processor block 11, the stream I/O block 12, the AVIO block 13, and the memory 14, and the external memory 15. In addition, the memory IF block 14, in response to the request from the processor block 11, ensures a transfer bandwidth between each of the processor block 11, the stream I/O block 12, the AVIO block 13, and the memory IF block 14, and the external memory 15, as well as performing latency assurance.

Next, the configuration of the processor block 11 is described in detail.

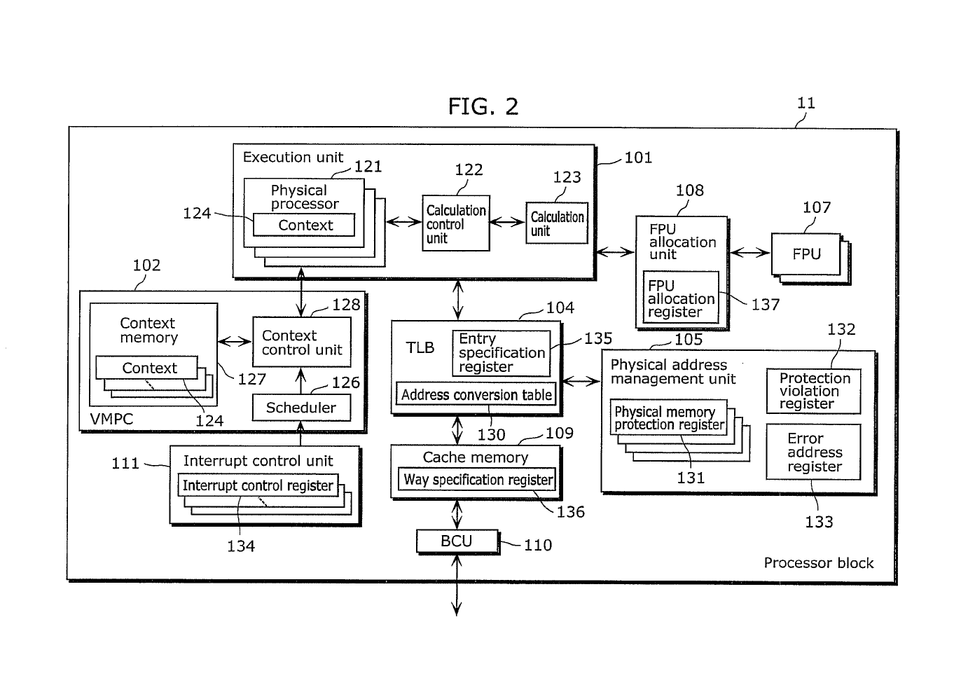

FIG. 2 is a functional block diagram showing a configuration of the processor block 11.

The processor block 11 includes: an execution unit 101, a virtual multiprocessor control unit (VMPC) 102; a translation lookaside buffer (TLB) 104; a physical address management unit 105; a floating point number processing unit (FPU) 107; an FPU allocation unit 108; a cache memory 109, a BCU 110; and an interrupt control unit 111.

Here, the processor block 11 according to the embodiment of the present invention functions as a virtual multiprocessor (VMP). The virtual multiprocessor is generally a type of instruction parallel processor which performs, by time division, functions of a plurality of logical processors (LP). Here, one LP substantially corresponds to one context that is set for a register group for a physical processor (PP) 121. Through control of a frequency of a time slot TS allocated to each LP, it is possible to keep a load balance between each application to be executed by each LP. Note that for a configuration and operation of the VMP, a representative example is disclosed in Patent Reference 3 (Japanese Unexamined Patent Application Publication No. 2003-271399), and thus detailed description thereof is omitted here.

In addition, the processor block 11 functions as a multithread pipeline processor (multithread processor). The multithread pipeline processor simultaneously processes a plurality of threads, and increases processing efficiency by processing the plurality of threads to fill a vacancy in an execution pipeline. Note that for a configuration and operation of the multithread pipeline processor, a representative example is disclosed in Patent Reference 4 (Japanese Unexamined Patent Application Publication No. 2008-123045), and thus detailed description thereof is omitted here.

The execution unit 101 simultaneously executes a plurality of threads. The execution unit 101 includes: a plurality of physical processors 121, a calculation control unit 122, and a calculation unit 123.

Each of the plurality of physical processors 121 includes a register. Each register holds one or more contexts 124. Here, the context 124 is control information, data information, and so on that correspond to each of the plurality of threads (LP) and are necessary for executing the corresponding thread. Each physical processor 121 fetches and decodes an instruction in the thread (program), and issues a decoding result to the calculation control unit 122.

The calculation unit 123 includes a plurality of calculators and simultaneously executes a plurality of threads.

The calculation control unit 122 performs pipeline control in the multithread pipeline processor. Specifically, the calculation control unit 122 allocates, first, the plurality of threads to a calculator included in the calculation unit 123 so as to fill the vacancy in the execution pipeline, and causes the threads to be executed.

The VMPC 102 controls virtual multithread processing. The VMPC 102 includes: a scheduler 126, a context memory 127, and a context control unit 128.

The scheduler 126 is a hardware scheduler which performs scheduling for determining, according to priority among the threads, an order of executing the threads and the PP that is to execute each thread. Specifically, the scheduler 126 switches the thread to be executed by the execution unit 101 by assigning or unassigning an LP to the PP.

The context memory 127 stores a plurality of contexts 124 each corresponding to one of the LPs. Note that the context memory 127 or a register included in each of the physical processors 121 corresponds to a holding unit according to the present invention.

The context control unit 128 performs what is called restore and save of context. Specifically, the context control unit 128 writes, into the context memory 127, the context 124 held by the physical processor 121 having completed an execution. In addition, the context control unit 128 reads, from the context memory 127, the context 124 of the thread that is to be executed, and transfers the read context 124 to the physical processor 121 assigned with the LP corresponding to the thread.

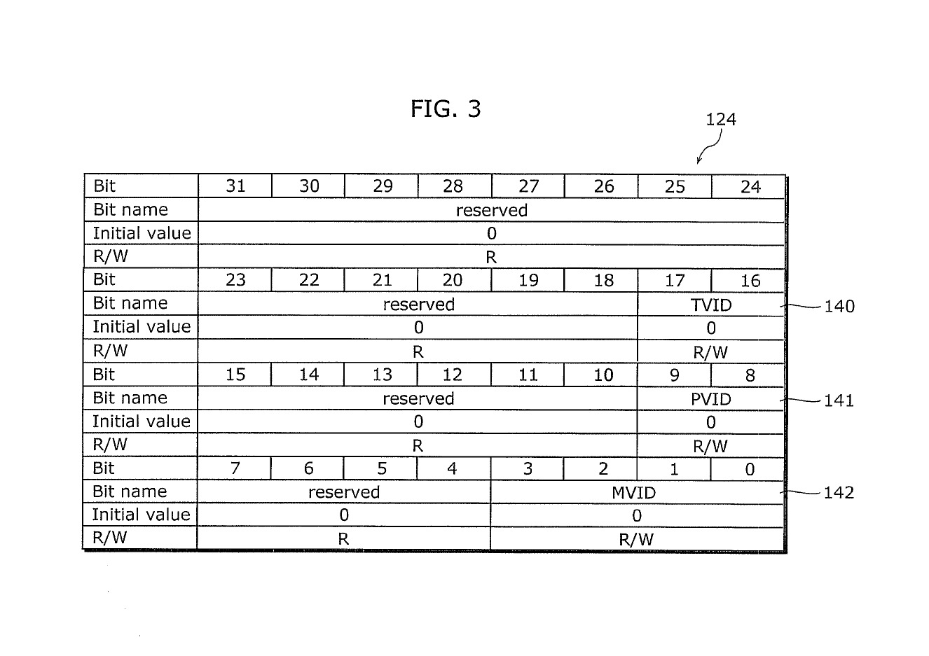

FIG. 3 is a diagram showing a configuration of one context 124. Note that FIG. 3 does not illustrate normal control information, normal data information, and so on that are necessary for executing the threads, but shows only the information newly added to the context 124.

As shown in FIG. 3, the context 124 includes: a TLB access virtual identifier (TVID) 140, a physical memory protection virtual identifier (PVID) 141, and a memory access virtual identifier (MVID) 142.

These TVID 140, PVID 141, and MVID 142 are tag information indicating whether each of the threads (LPs) belongs to host processing or media processing.

The TVID 140 is used for setting a plurality of virtual memory protection groups. For example, a different TVID 140 is assigned to each of the threads for host processing and the threads for media-processing. The execution unit 101 can generate, using the TVID 140, page management information in a logical address space for each of host processing and media processing, independently from each other.

The PVID141 is used for limiting an access to a physical memory region.

The MVID 142 is used for setting a mode of access to the memory IF block 14. The memory IF block 14 determines, using this MVID 142, whether priority is given to latency (with emphasis on responsiveness) or bus bandwidth (performance assurance).

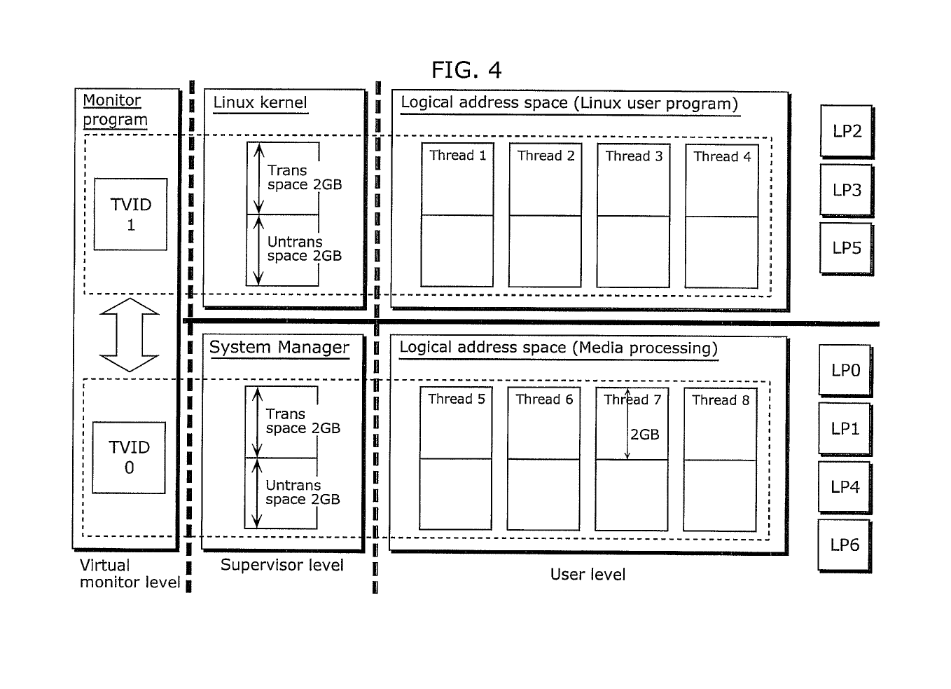

FIG. 4 is a diagram schematically showing management of the logical address space in the processor system 10. As shown in FIG. 4, the processor system 10 is controlled in three hierarchies: user level, supervisor level, and virtual monitor level.

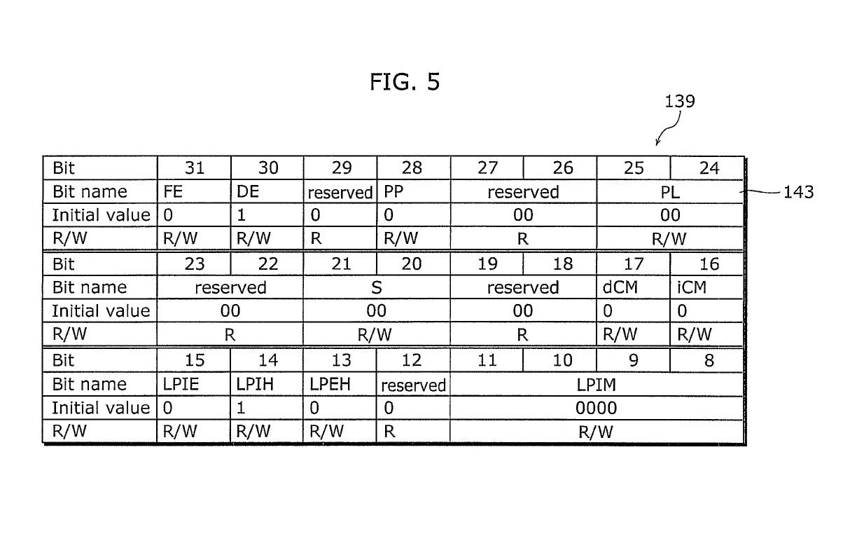

In addition, these hierarchies are set as values of the PL 143 (privilege level) included in a processor status register (PSR139) shown in FIG. 5. Note that the PSR 139 is a register included in the processor block 11.

Here, the user level is a hierarchy for performing control on each thread (LP). The supervisor level is a hierarchy corresponding to an operating system (OS) which controls a plurality of threads. For example, as shown in FIG. 4, the supervisor level includes: Linux kernel that is an OS for host processing, and System Manager that is an OS for media processing.

The virtual monitor level is a hierarchy for controlling a plurality of OS at the supervisor level. Specifically, the OS (monitor program) at the virtual monitor level distinguishes between logical address spaces, using the TVID 140. In other words, the processor system 10 manages the logical address spaces such that the logical address spaces used by the plurality of OS do not interfere with each other. For example, the TVID140, PVID 141, and MVID 142 of each context allows setting only at the virtual monitor level.

In addition, the OS at the virtual monitor level is a division unit according to the present invention, which divides the plurality of resources of the processor system 10 into: a first resource to be associated with threads belonging to host processing, and a second resource to be associated with threads belonging to media processing. Here, specifically, the resource is: a memory region of the external memory 15 (logical address space and physical address space); a memory region of the cache memory 109; a memory region of the TLB 104; and the FPU 107.

Thus, by dividing the resources at the virtual monitor level, a designer can design the OS for host processing and media processing in the same manner as in the case where host processing and media processing are executed by independent processors.

The TLB104 is a type of cache memory, and holds an address conversion table 130 that is part of a page table indicating a correspondence relationship between a logical address and a physical address. The TLB 104 performs conversion between the logical address and physical address, using the address conversion table 130.

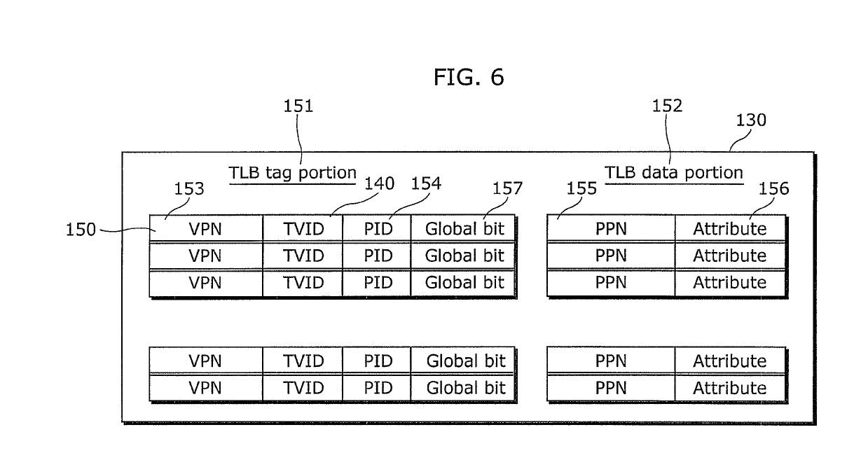

FIG. 6 is a diagram showing a configuration of the address conversion table 130.

As shown in FIG. 6, the address conversion table 130 includes a plurality of entries 150. Each entry 150 includes: a TLB tag portion 151 for identifying the logical address, and a TLB data portion 152 associated with the TLB tag portion 151. The TLB tag portion 151 includes: VPN 153, TVID 140, PID 154, and a global bit 157. The TLB data portion 152 includes PPN 155 and Attribute 156.

The VPN 153 is a logical address at the user level, and is specifically a page No. of the logical address space.

The PID 154 is an ID for identifying a process using current data.

The PPN 155 is a physical address associated with the current TLB tag portion 151, and is specifically a page No. of the physical address space.

The Attribute 156 indicates an attribute of the data associated with the current TLB tag portion 151. Specifically, the Attribute 156 indicates: whether or not access to the current data is possible; whether or not the current data is to be stored in the cache memory 109; whether or not the current data has privilege; and so on.

Thus, the TLB tag portion 151 includes a process identifier (PID) 154 in addition to the logical address. In the processor system 10, a plurality of logical address spaces are used for each process, using this PID 154. In addition, a comparison operation of the PID 154 is suppressed by the global bit 157 which is also included in the LTB tag portion 151. With this, the processor system 10 realizes an address conversion that is common to the process. In other words, only when the PID that is set for each process matches the PID 154 in the TLB tag portion 151, the address conversion is performed using the TLB entry 150. In addition, when the global bit 157 is set for the TLB tag portion 151, the comparison of the PID 154 is suppressed, and the address conversion common to all processes is performed.

Here, the TVID 140 in the TLB tag portion 151 specifies to which virtual space each LP is to belong. This allows each of the plurality of LPs belonging to the plurality of OS to have a specific TVID 140, thus allowing the plurality of OS to use, independently from each other, an entire virtual address space composed of the PID and logical address.

In addition, with such a configuration allowing each LP to have an ID indicating the division, it is possible to associate a plurality of LPs with a plurality of resources. This allows flexible designing of a configuration, as to which subsystem the LPs in the entire system should belong to, and so on.

Note that the global bit 157 suppresses the comparison operation of the PID 154, but does not suppress the function of the TVID 140 that is to specify to which virtual space each LP belongs.

In addition, the TLB 104 manages the logical address spaces used by the plurality of threads (LPs).

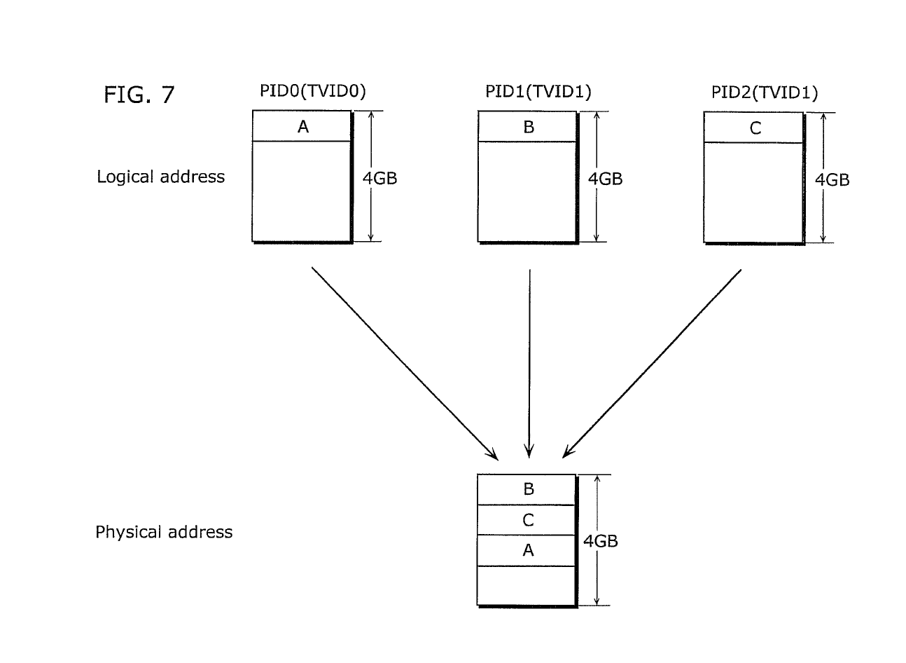

FIG. 7 is a diagram schematically showing a correspondence relationship between the logical address and the physical address in the processor system 10. As described above, the TLB 104 associates one physical address (PPN155) with a set of the logical address (VPN153), the PID 154, and the TVID 140 for each process. Thus, at the supervisor level above the LPs having the same TVID, it is possible to distinguish first, at the supervisor level, the logical address of each process by associating one physical address with the set of the logical address (VPN153) and the PID 154 for each process, and then to associate the distinguished logical address with the physical address.

Here, in updating the TLB 104, a TVID which is set to the LP to be updated is set as the TVID 140 of the entry to be updated.

Furthermore, the TLB 104 associates one physical address (PPN155) with a set of the logical address (VPN153) and the PID 154 for each process, which includes the TVID 140. This allows the TLB 104 to assign, at the virtual monitor level, an independent logical address space to each of host processing and media processing, by setting a different TVID for each of host processing and media processing.

In addition, the TLB 104 includes an entry specification register 135. The entry specification register 135 holds information for specifying the entry 150 to be assigned to the TVID 140.

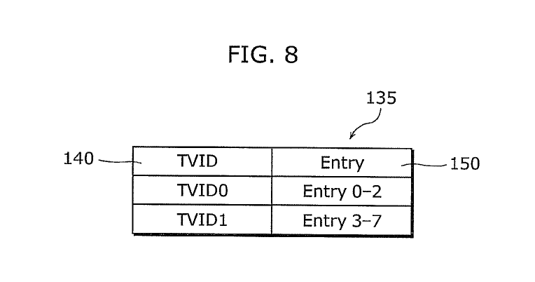

FIG. 8 is a diagram showing an example of data stored in the entry specification register 135. As shown in FIG. 8, the entry specification register 135 holds a correspondence relationship between the TVID 140 and the entry 150. In addition, the entry specification register 135 is set and updated by the OS (monitor program) at the virtual monitor level.

The TLB 104, using the information that is set for the entry specification register 135, determines the entries 150 to be used for each TVID 140. Specifically, the TLB 104 replaces the data of the entry 150 corresponding to the TVID 140 of an LP, in the case of TLB miss (when the address conversion table 130 does not hold the logical address (the TLB tag portion 151) that is input from the LP).

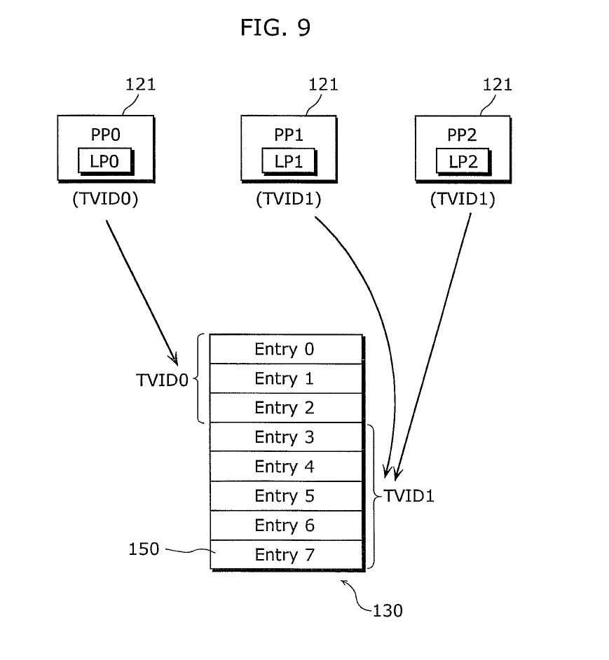

FIG. 9 is a diagram schematically showing an assignment state of the entries 150 in the TLB 104.

As shown in FIG. 9, the plurality of entries 150 are shared between a plurality of LPs. Furthermore, the TLB 104, using the TVID 140, causes the entries 150 to be shared between the LPs having the same TVID 140. For example, an LP0 having TVID0 is assigned with entries 0 to 2, and an LP1 and an LP2 having TVID1 are assigned with entries 3 to 7. This allows the TLB104 to use the entries 0 to 2 for threads belonging to host processing, and to use the entries 3 to 7 for threads belonging to media processing.

Note that an entry 150 which is updatable from both the LP0 having the TVID0 and the LP1 and LP2 having the TVID1 may be set.

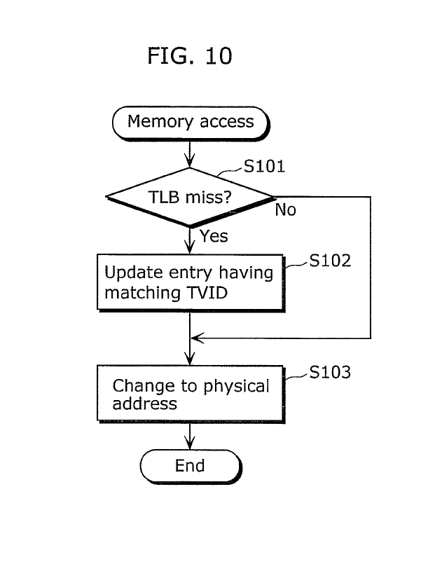

FIG. 10 is a flowchart showing a flow of processing by the TLB 104.

As shown in FIG. 10, in case of occurrence of an access from an LP to the external memory 15, the TLB 104 determines whether or not the TLB 104 stores a logical address that is the same as the logical address (VPN153, TVDE 140, and PID 154) input from the LP that is an access source (S101).

When the same logical address is not stored, that is, in the case of TLB miss (Yes in S101), the TLB 104 updates the entry 150 assigned to the TVID 140 of the LP that is the access source. In other words, the TLB 104 updates the entry 150 of the same TVID 140 as the TVID 140 of the access source LP (S102). Specifically, the TLB 104 reads, from a page table stored in the external memory 15 or the like, a correspondence relationship between the logical address and the physical address that are determined as the TLB miss, and stores the read correspondence relationship in the entry 150 assigned to the TVID 140 of the access source LP.

Next, the TLB 104 converts the logical address to the physical address, using the correspondence relationship that is updated (S103).

On the other hand, in step S101, when the same logical address as the logical address input from the LP is stored, that is, in the case of TLB hit (No in S101), the TLB 104 converts the logical address to the physical address, using the correspondence relationship that is determined as the TLB hit (S103).

Here, the page table stored in the external memory 15 or the like is generated in advance such that the physical address in the external memory 15 is assigned to each TVID 140 or each PVID 141. This page table is generated and updated by, for example, the OS at the supervisor level or the virtual monitor level.

Note that here, the virtual address space has been divided according to what is called a full associative method by which address conversion is performed by comparing, with the TVID 140 of each of the LPs, the TVID 140 included in the TLB tag portion 151; however, it is also possible, for example, to divide the virtual address space using the TVID 140 according to what is called a set associative method that is a method of specifying and comparing the entry 150 using a hush value based on the TVID 140, or having a separate TLD for each value of the TVID140.

The physical address management unit 105 performs access protection on the physical address space, using the PVID 141. The physical address management unit 105 includes: a plurality of physical memory protection registers 131, a protection violation register 132, and an error address register 133.

Each physical memory protection register 131 holds information indicating, for each physical address range, LPs that are accessible to the physical address range.

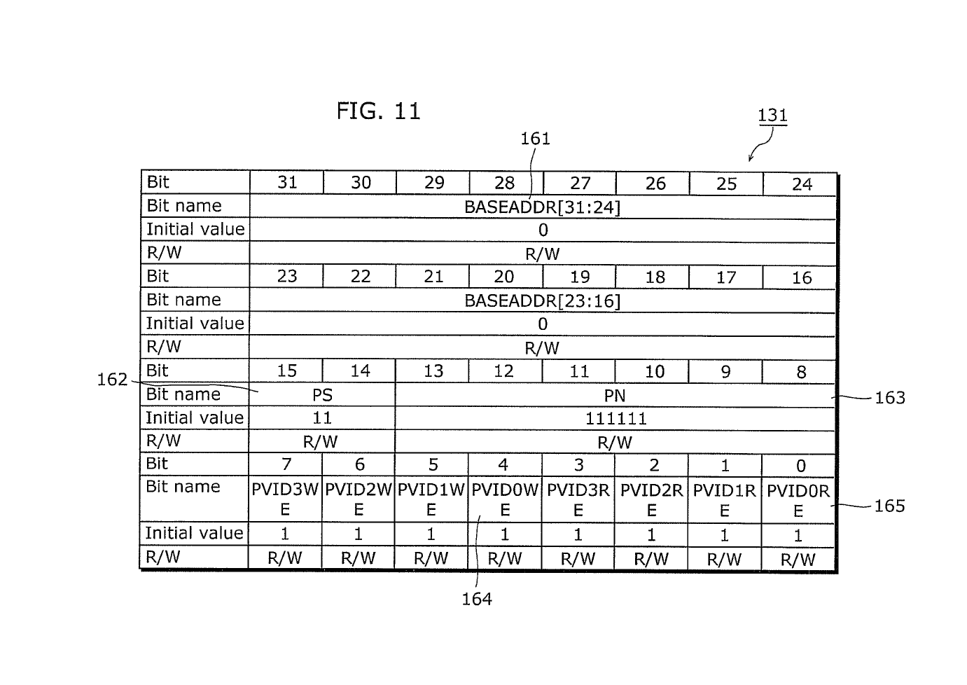

FIG. 11 is a diagram showing a configuration of the information held by one physical memory protection register 131. As shown in FIG. 11, the physical memory protection register 131 holds information including: BASEADDR 161; PS 162; PN 163; PVID0WE to PVID3WE 164; and PVID0RE to PVID3WE 165.

The BASEADDR 161, PS 162, and PN 163 are information indicating a physical address range. Specifically, the BASEADDR 161 is higher 16-bit of an initial address of the physical address range to be specified. The PS162 indicates a page size. For example, as a page size, 1 KB, 64 KB, 1 MB, or 64 MB is set. The PN 163 indicates the number of pages in the page size that is set for the PS 162.

The VID0WE to PVID3WE 164 and the PVID0RE to PVID3RE 165 indicate the PVID 141 of an LP that is accessible to the physical address range specified by the BASEADDR 161, the PS 162, and the PN 163.

Specifically, each of the PVID0WE to PVID3WE 164 is provided, one bit for each PVID141. In addition, the PVID0WE to PVID3WE 164 indicate whether or not the LP assigned with a corresponding PVID 141 is able to write the data into the physical address range that is specified.

Specifically, each of the PVID0RE to PVID3RE 165 is provided, one bit for each PVID 141. In addition, the PVIO0RE to PVID3RE 165 indicate whether or not the LP assigned with a corresponding PVID 141 is able to read the data within the physical address range that is specified.

Note that it is assumed here that four types of PVID 141 are assigned to a plurality of LPs, but it is only necessary to assign two or more PVID 141 to the LPs.

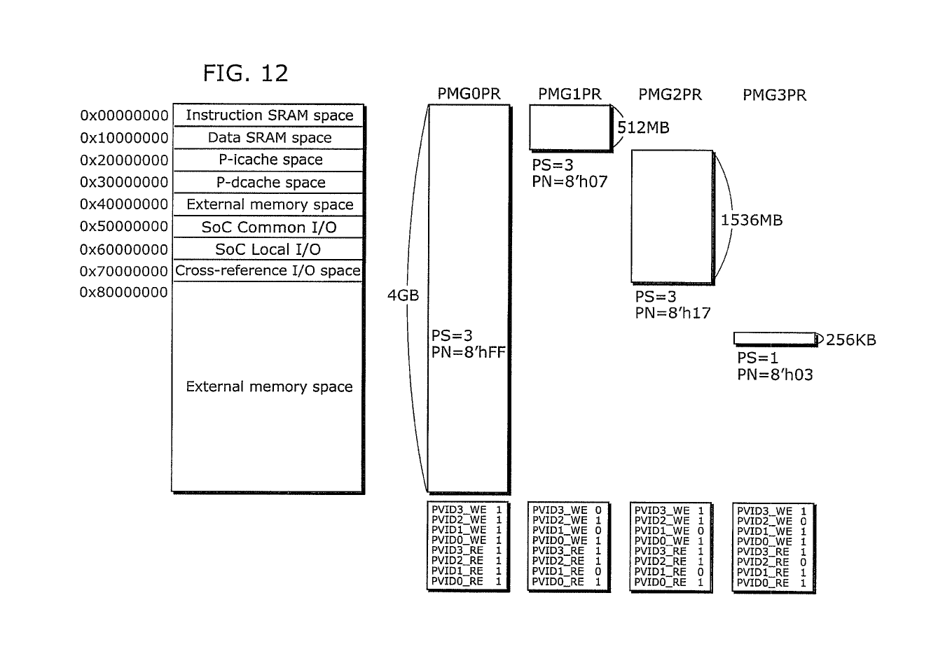

FIG. 12 is a diagram showing an example of the physical address space protected by the PVID141. In addition, it is assumed here that the physical address management unit 105 includes four physical memory protection registers 131 (PMG0PR to PMG3PR). In addition, PVID0 is assigned to an LP group for Linux (host processing), PVID1 is assigned to an LP group for image processing among the LPs for media processing, PVID 2 is assigned to an LP group for audio processing among LPs for media processing, and PVID3 is assigned to an LP group for System Manager (the OS for media processing).

In addition, the physical address management unit 105 generates an exceptional interrupt when an LP accesses a physical address that is not permitted by the PVID 141 of the LP, and writes, to the protection violation register 132, access information in which the error occurs, and also writes, to the error address register 133, a physical address of a destination of the access having caused the error.

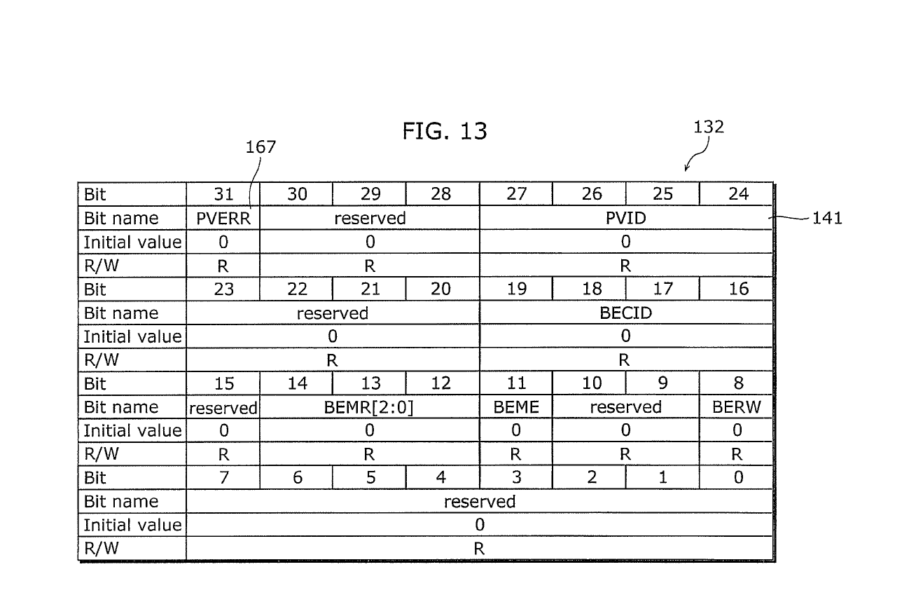

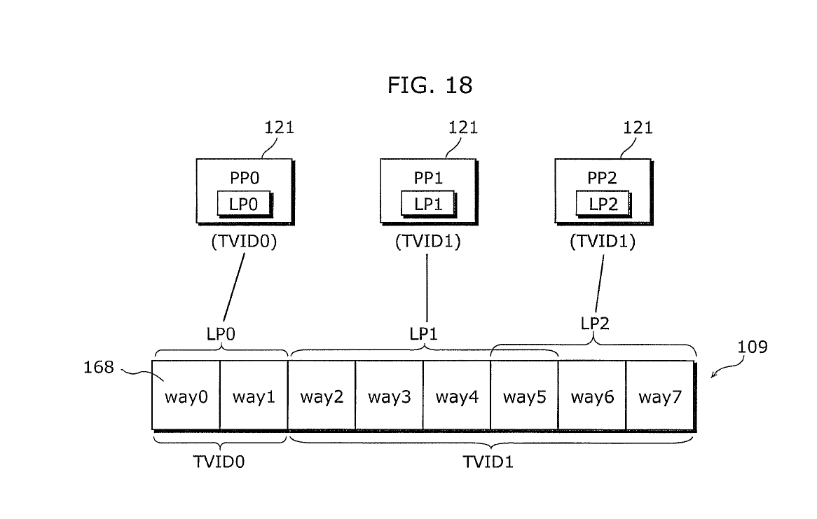

FIG. 13 FIG. 18 is a diagram showing a configuration of the access information held by the protection violation register 132. As shown in FIG. 13, the access information held by the protection violation register 132 includes: PVERR 167 and PVID 141. The PVERR 167 indicates whether or not the error is a protection violation of the physical memory space (an error caused by an LP having accessed the physical address that is not permitted by the PVID 141 of the LP). For the PVID 141, a PVID 141 in which the protection violation of the physical memory space has occurred is set.

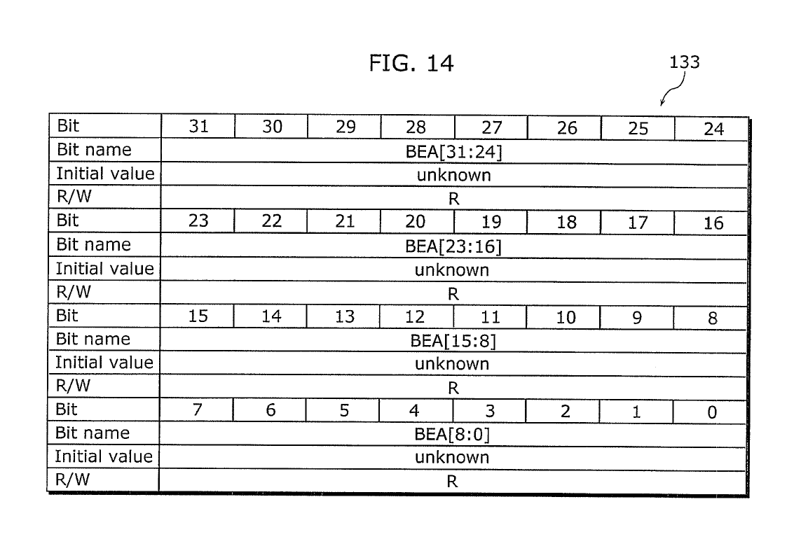

FIG. 14 is a configuration of information held by the error address register 133. As shown in FIG. 14, the error address register 133 holds a physical address (BEA [31:0]) of the destination of the access that has caused the error.

As described above, by protecting the physical address using the PVID 141, it is possible to increase system robustness. Specifically, in debugging, the designer can easily determine which one of image processing and audio processing has caused the error, from the physical address in which the error has occurred or the PVID 141. In addition, in debugging host processing, it is possible to debug a failure occurring at an address that does not allow writing image processing or the like, without suspecting the failure in the image processing.

The FPU allocation unit 108 allocates a plurality of FPUs 107 to LPs. This FPU allocation unit 108 includes an FPU allocation register 137.

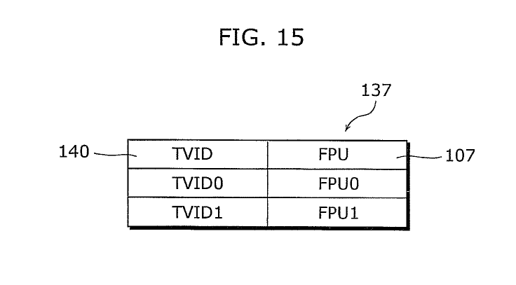

FIG. 15 is a diagram showing an example of data stored in the FPU allocation register 137. As shown in FIG. 15, in the FPU allocation register 137, an FPU 107 is associated with each TVID 140. In addition, the FPU allocation register 137 is set and updated by the OS (monitor program) at the virtual monitor level.

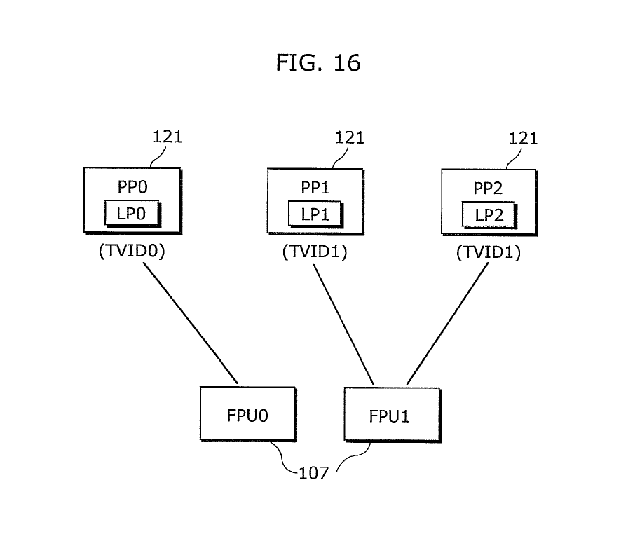

FIG. 16 is a diagram schematically showing allocation processing of the FPU 107 by the FPU allocation unit 108.

As shown in FIG. 16, a plurality of FPUs 107 are shared by a plurality of LPs. Furthermore, the FPU allocation unit 108, using the TVID 140, causes the FPUs 107 to be shared between the LPs having the same TVID 140. For example, the FPU allocation unit 108 allocates the FPU0 to the LP0 having TVID0, and allocates the FPU1 to the LP1 and LP2 having TVID1.

In addition, the LP executes a thread, using the FPU 107 allocated by the FPU allocation unit 108.

The cache memory 109 is a memory which temporarily stores the data used for the processor block 11. In addition, for an LP having a different TVID 140, the cache memory 109 uses an independent and different data region (way 168). The cache memory 109 includes a way specification register 136.

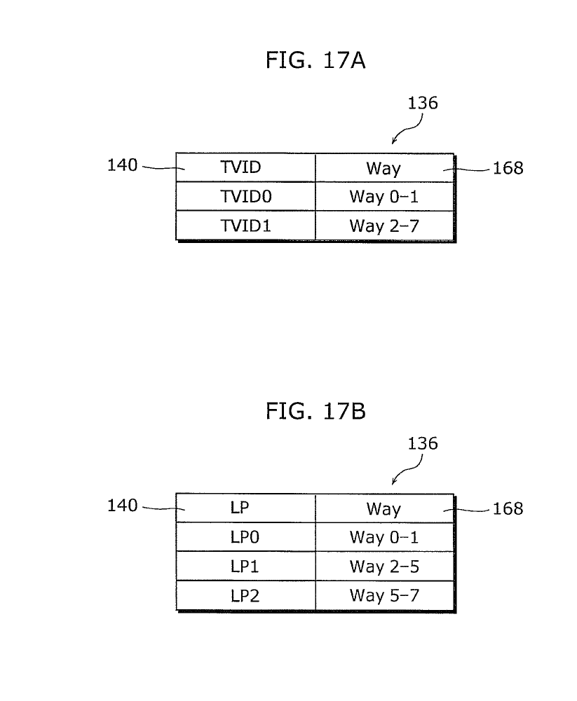

FIGS. 17A and 17B are diagrams each showing an example of data stored in the way specification register 136.

As shown in FIG. 17A, the way specification register 136 is associated with a way 168 for each TVID 140. In addition, the way specification register 136 is set and updated by the OS (monitor program) at the virtual monitor level.

Note that as shown in FIG. 17B, the way 168 may be associated with each LP. In this case, for example, the context 124 includes information of the way used by the LP, and the OS at the virtual monitor level or the supervisor level sets and updates the way specification register 136 with reference to the context 124.

FIG. 18 is a diagram schematically showing the processing of allocating the way 168 performed by the cache memory 109.

As shown in FIG. 18, the cache memory 109 has a plurality of ways 168 (way0 to way7) as a unit of data storage. This cache memory 109 causes, using the TVID 140, the way 168 to be shared between LPs having the same TVID140. For example, the LP0 having TVID0 is assigned with way0 to way1, and the LP1 and LP2 having TVID1 are assigned with way2 to way7. With this, the cache memory 109 caches the data of threads belonging to host processing into a way0 to a way1, and caches the data of threads belonging to media processing into a way2 to a way7.

Thus, the cache memory 109 prevents the LPs having different TVIDs 140 from driving out the cache data of each other.

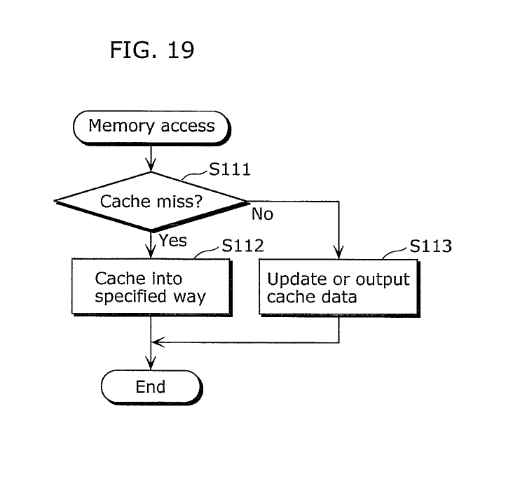

FIG. 19 is a flowchart showing a flow of processing by the cache memory 109.

As shown in FIG. 19, in case of occurrence of an access from an LP to the external memory 15, the cache memory 109 determines first whether or not the cache memory 109 stores the same address as an address (physical address) that is input from an access source LP (S111).

When the address is not stored, that is, in the case of cache miss (Yes in S111), the cache memory 109 caches, into the way 168 specified by the way specification register 136, the address and data that are input from the access source LP (S112). Specifically, in the case of read access, the cache memory 109 reads the data from the external memory 15 or the like, and stores the read data into the way 168 specified by the way specification register 136. In addition, in the case of write access, the cache memory 109 stores, into the way 168 specified by the way specification register 136, the data that is input from the access source LP.

On the other hand, in step S111, when the same address as the address input from the access source LP is stored, that is, in the case of cache hit (No in S111), the cache memory 109 updates the data that is determined as cache hit (at the time of write access) or outputs the cache-hit data to the access source LP (at the time of read access) (S113).

The BCU 110 controls a data transfer between the processor block 11 and the memory IF block 14.

The interrupt control unit 111 detects, requests, and permits an interrupt, and so on. The interrupt control unit 111 includes a plurality of interrupt control registers 134. For example, the interrupt control unit 111 includes 128 interrupt control registers 134. The interrupt control unit 111, with reference to the interrupt control registers 134, transfers an interrupt to a thread (LP) corresponding to an interrupt factor of the interrupt that has occurred.

To the interrupt control registers 134, a thread of the destination of the interrupt corresponding to the interrupt factor is set.

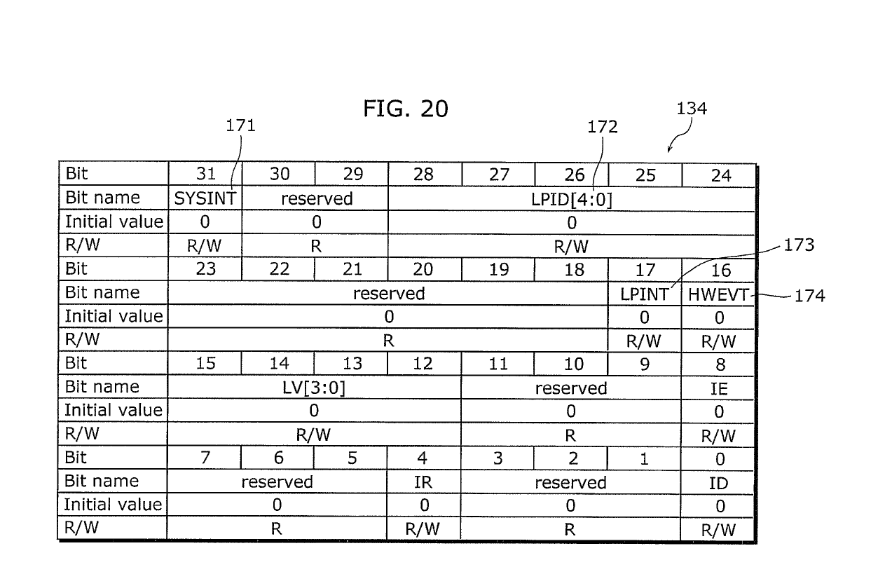

FIG. 20 is a diagram showing a configuration of one interrupt control register 134. The interrupt control register 134 shown in FIG. 20 includes: a system interrupt 171 (SYSINT), an LP identifier 172 (LPID), an LP interrupt 173 (LPINT), and an HW event 174 (HWEVT) that are associated with the interrupt factor.

The system interrupt 171 indicates whether or not the interrupt is a system interrupt (global interrupt). The LP identifier 172 indicates an LP that is the destination of the interrupt. The LP interrupt 173 indicates whether or not the interrupt is LP interrupt (local interrupt). The HW event 174 indicates whether or not to cause a hardware event, based on the interrupt factor.

In the case of system interrupt, the interrupt control unit 111 transmits an interrupt to an LP currently executing a thread. In addition, in the case of LP interrupt, the interrupt control unit 111 transmits an interrupt to the LP indicated by the LP identifier 172. In addition, in the case of the hardware event, the interrupt control unit 111 transmits a hardware event to the LP indicated by the LP identifier 172. This hardware event wakes up the LP.

In addition, the system interrupt 171 and the LP identifier 172 can be rewritten only by the OS at the virtual monitor level (monitor program), and the LP interrupt 173 and the HW event 174 can be rewritten only by the OS at the virtual monitor level and the supervisor level.

Next, memory access management in the processor system 10 is described.

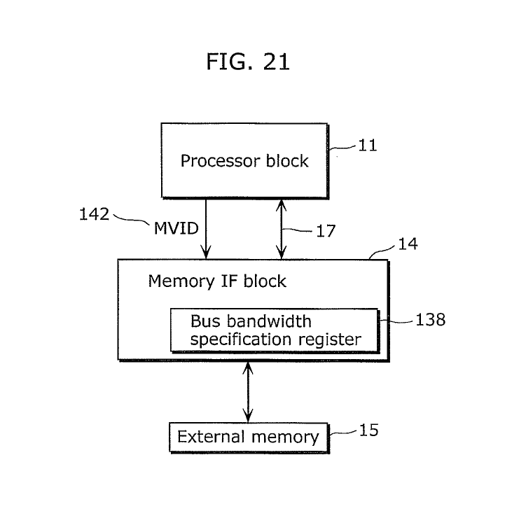

FIG. 21 is a diagram schematically showing a state of memory access management in the processor system 10. As shown in FIG. 21, the processor block 11 transmits the MVID 142 to the memory IF block 14. The memory IF block 14, using the MVID 142, allocates a bus bandwidth to each MVID142, and accesses the external memory 15, using the bus bandwidth allocated to the MVID142 of a thread that is a source of an access request.

In addition, the memory IF block 14 includes a bus bandwidth specification register 138.

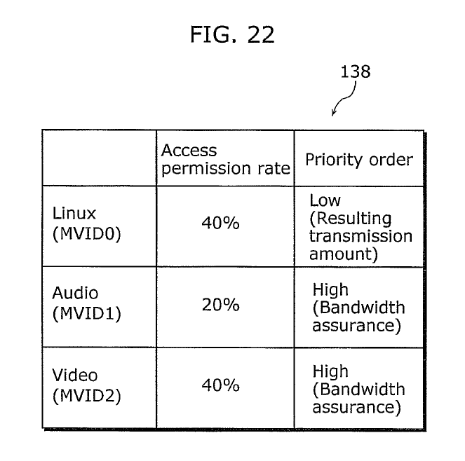

FIG. 22 is a diagram showing an example of data held by the bus bandwidth specification register 138 in the memory IF block 14. Note that in FIG. 22, a different MVID 142 is assigned to each of: Linux that is host processing; audio processing (Audio) included in media processing, and image processing (Video) included in media processing.

As shown in FIG. 22, the memory IF block 14 allocates the bus bandwidth to each MVID 142. In addition, priority order is determined for each MVID 142, and an access to the external memory 15 is performed based on the priority order.

This ensures the bandwidth necessary for each MVID142, and also assures access latency that is requested. Thus, the processor system 10 can achieve assurance of performance and real-timeness of a plurality of applications.

In addition, even when the memory IF block 14 and the processor 11 are connected to each other only via one data bus 17, it is also possible, by dividing the bus bandwidth using the MVID 142, to perform the same control as in the case where the memory IF block 14 and the processor block 11 are connected via a plurality of data buses. In other words, it is possible to perform the same control as in the case of dividing the bus for a plurality of blocks.

Note that Japanese Unexamined Patent Application Publication No. 2004-246862 (Patent Reference 5) discloses a representative example of the technique of ensuring the bus bandwidth and assuring latency in response to access requests from a plurality of blocks, and therefore the detailed description thereof is omitted here.

In addition, the processor system 10 allows arbitrary setting of a ratio between processing time for media processing and processing time for host processing, using the TVID 140 and a conventional VMP function. Specifically, for example, the OS at the virtual monitor level sets, for the register (not shown) included in the VMPC 102, a processing time ratio (a ratio in processing time between media processing and host processing) for each TVID 140. With reference to this processing time ratio that is set and the TVID 140 of each thread, the VMPC 102 switches the thread to be executed by the execution unit 101 such that the processing time ratio is satisfied.

Next, resource division processing that is performed by the OS at the virtual monitor level (monitor program) is described.

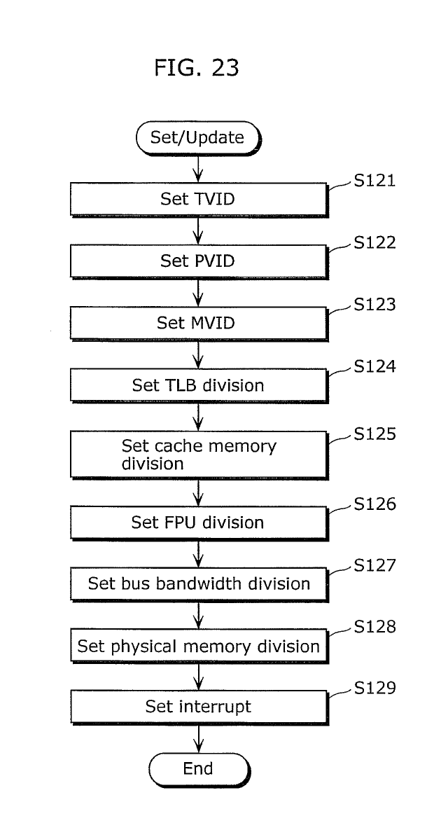

FIG. 23 is a flowchart showing a flow of the resource division processing by the monitor program.

First, the monitor program divides a plurality of threads into a plurality of groups, by setting the TVID 140, PVID 141, and MVID 142 of each of a plurality of contexts 124 (S121, S122, and S123).

Next, the monitor program divides a plurality of entries 150 included in the TLB 104 into first entries to be associated with host processing and second entries to be associated with media processing, by setting, for the entry specification register 135, a correspondence relationship between the TVID 140 and each entry 150 (S124).

With reference to the correspondence relationship set for the entry specification register 135 and the TVID 140 of the thread of the access source, the TLB 104 allocates each entry 150 to threads belonging to host processing and threads belonging to media processing.

In addition, the monitor program divides the plurality of ways 168 in the cache memory 109 into a first way to be associated with host processing and a second way to be associated with media processing, by setting, for the way specification register 136, a correspondence relationship between the TVID 140 (or LP) and the way 168 (S125).

With reference to the correspondence relationship set for the way specification register 136 and the TVID 140 of the access source thread, the TLB 104 allocates each way 168 to threads belonging to host processing and threads belonging to media processing.

In addition, the monitor program divides the plurality of FPUs 107 into a first FPU to be associated with host processing and a second FPU to be associated with media processing, by setting, for the FPU allocation register 137, a correspondence relationship between the TVID 140 and the FPU 107 (S126).

With reference to the correspondence relationship set for the FPU allocation register 137 and the TVID 140 of the thread, the FPU allocation unit 108 allocates each FPU 107 to threads belonging to host processing and threads belonging to media processing.

In addition, the monitor program divides the bus bandwidth between the external memory 15 and the memory IF block 14 into a first bus bandwidth to be associated with host processing and a second bus bandwidth to be associated with media processing, by setting, for the bus bandwidth specification register 138, a correspondence relationship between the MVID 142 and the bus bandwidth (S127).

With reference to the correspondence relationship set for the bus bandwidth specification register 138 and the MVID 142 of the access source thread, the memory IF block 14 allocates each bus bandwidth to threads belonging to host processing and threads belonging to media processing.

In addition, the monitor program generates a page table indicating a correspondence relationship between the physical address and the logical address. In performing this, the monitor program divides the physical address space of the external memory 15 into a first physical address range to be associated with host processing and a second physical address range to be associated with media processing, by setting the correspondence relationship between the PVID 141 and the physical address, and also allocates the first physical address to threads for host processing and the second physical address to threads for media processing (S128). In addition, the monitor program protects the physical address by setting, for the physical memory protection register 131, the correspondence relationship between the PVID 141 and the physical address.

In addition, the monitor program sets, in the interrupt control register 134, an LP to be interrupted and so on, corresponding to each interrupt factor (S129). This allows the monitor program to perform an interrupt control on host processing and media processing, independently from each other.

With reference to the correspondence relationship set for the interrupt control register 134 and the interrupt factor, the interrupt control unit 111 transmits an interrupt to a thread corresponding to the interrupt factor.

Note that the order of each setting by the monitor program is not limited to an order shown in FIG. 23.

Note that instead of generating the page table by the monitor program, each OS at the supervisor level, which is assigned with the TVID 140, can also determine a logical address corresponding to the physical address allocated to each OS and generate a page table independently; thus, the present invention is not limited to the present embodiment.

As described above, the processor system 10 according to the present embodiment allows increasing area efficiency by including a single processor block 11 that performs host processing and media processing by sharing resources. Furthermore, the processor system 10 assigns different tag information (TVID 140, PVID 141, and MVID 142) to threads for host processing and threads for media processing, and also divides the resource belonging to the processor system 10 in association with the tag information. This allows the processor system 10 to allocate an independent resource to each of host processing and media processing. Accordingly, since no competition occurs for resources between the host processing and media processing, the processor system 10 can achieve performance assurance and increase robustness.

In addition, the physical address management unit 105 generates an interrupt when each thread attempts to access, using the PVID 141, a physical address range that is other than the specified physical address range. This allows the processor system 10 to increase system robustness.

Thus far, the processor system 10 according to the embodiment of the present invention has been described, but the present invention is not limited to this embodiment.

For example, in the description above, an example in which the processor block 11 performs two types of processing, that is, host processing and media processing, has been described, but three or more types of processing including other processing may be performed. If this is the case, three or more types of TVID 140 corresponding to the three or more types of processing are assigned to a plurality of threads.

In addition, the processor system 10 according to the embodiment of the present invention allows, instead of using the identifier of each LP (LPID), specifying the TVID 140, the PVID 141, and the MVID 142 for each LP, thus allowing flexibly dividing each resource. In contrast, it is also possible to use the LPID for dividing each resource, but this does not allow sharing the resource between a plurality of LPs. In other words, it is possible to appropriately control the sharing and division of resources, by providing an ID to each resource and by each of the LPs having the ID of each resource.

Likewise, the types of the PVID 141 and the MVID 142 are not limited to the number described above, but it is only necessary to provide more than one type.

In addition, in the description above, as tag information for grouping a plurality of threads, three types of tag information the TVID 140, the PVID 141, and the MVID 142 have been described, but the processor system 10 may use only one tag information (for example, TVID 140). In other words, the processor system 10 may use TVID 140, instead of using PVID 141 and MVID 142, for physical address management and bus bandwidth control. In addition, the processor system 10 may use two types of tag information, and may use four or more types of tag information.

In addition, in the description above, the interrupt control register 134, the entry specification register 135, the way specification register 136, the FPU allocation register 137, and the page table have been described as being set and updated by the OS at the virtual monitor level (monitor program), but the OS at the supervisor level, according to an instruction from the OS at the virtual monitor level, may set and update the interrupt control register 134, the entry specification register 135, the way specification register 136, the FPU allocation register 137, and the page table. In other words, the OS at the virtual monitor level may notify the allocated resource to the OS at the supervisor level, and the OS at the supervisor level may set and update the interrupt control register 134, the entry specification register 135, the way specification register 136, the FPU allocation register 137, and the page table such that the notified resource is used.

In addition, each processing unit included in the processor system 10 according to the present embodiment is typically realized as an LSI that is an integrated circuit. These functions may be separately configured as a single chip, or may be configured as a single chip to include part or all of these functions.

The LSI here may also be called an IC, a system LSI, a super LSI, or an ultra LSI, depending on the degree of integration.

In addition, the integration method is not limited to the LSI, but may also be realized as a dedicated circuit or a general-purpose processor. After manufacturing the LSI, a field programmable gate array (FPGA) that allows programming or a reconfigurable processor in which connections of circuit cells and settings within the LSI are reconfigurable may be used.

Furthermore, when another integrated circuit technology appears to replace the LSI as a result of development of the semiconductor technology or some derivative technique, these function blocks may naturally be integrated using the technology. The possibility of application of bio technology and so on can be considered.

In addition, part or all of the functions of the processor system 10 according to the embodiments of the present invention may be realized by the execution unit 101 and so on executing a program.

Furthermore, the present invention may be the program, and may be a recording medium on which the program is recorded. In addition, it goes without saying that the program can be distributed via a transmission medium such as the Internet.

In addition, at least part of the functions of the processor system 10 and the variation thereof according to the embodiments above may be combined.

Although only some exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The present invention is applicable to a multithread processor, and is particularly applicable to a multithread processor to be incorporated in a digital television, a DVD recorder, a digital camera, a cellular phone, and so on.

What is claimed is:

1. A multithread processor comprising:
an execution unit including at least one physical processor; and
a translation lookaside buffer (TLB) which includes a plurality of entries and converts a logical address to a physical address, the logical address being output from said execution unit,
wherein a plurality of logical processors are implemented on said at least one physical processor,
at least one first logical processor that is a part of said logical processors constitutes a first subsystem having a first virtual space,
at least one second logical processor that is a part of said logical processors and different from said at least one first logical processor constitutes a second subsystem having a second virtual space,
each of the first subsystem and the second subsystem has a plurality of processes,
the processes are assigned to said logical processors, and
the logical address includes:
a first TLB access virtual identifier for identifying one of the first subsystem and the second subsystem; and
a process identifier for identifying a corresponding one of the processes in each of the first subsystem and the second subsystem.

2. The multithread processor according to claim 1, further comprising
a first holding unit configured to hold the first TLB access virtual identifier that corresponds to each of said logical processors,
wherein said execution unit is configured to output the logical address including the first TLB access virtual identifier held in said first holding unit.

3. The multithread processor according to claim 2,
wherein each of said logical processors belongs to one of a plurality of levels including:
a first level that allows each of said logical processors to control itself;
a second level that allows said logical processor to control more than one logical processor included in the one of the first subsystem and the second subsystem to which said logical processor belongs; and
a third level that is higher than the first and the second levels, and
one of said logical processors that belongs to the third level rewrites the first TLB access virtual identifier held in said first holding unit.

4. The multithread processor according to claim 2,
wherein each of the entries in said TLB includes a second holding unit configured to hold a second TLB access virtual identifier for identifying one of the first subsystem and the second subsystem, and
said multithread processor, in updating the each of the entries, sets the second TLB access virtual identifier of the each of the entries that is to be updated, according to the first TLB access virtual identifier corresponding to one of said logical processors that is to perform the updating, the second TLB access virtual identifier being held in said second holding unit.

5. The multithread processor according to claim 1,
wherein said at least one first logical processor belongs to host processing, and
said at least one second logical processor belongs to media processing.

6. The multithread processor according to claim 5,
wherein the host processing is performing system control, and
the media processing is performing one of compression and decompression on video.

7. A digital television system comprising
said multithread processor according to claim 5,
wherein the host processing is performing system control, and
the media processing is performing decompression on video.
